(19) United States
(12) Patent Application Publication
(10) Pub. No.: US 2024/0095624 A1
(43) Pub. Date: Mar. 21, 2024

(54) DEVICE, SYSTEM, AND METHOD OF AUTONOMOUS RESOURCE PLANNING

(71) Applicant: GRENE ROBOTICS (INDIA) PRIVATE LIMITED, Hyderabad (IN)

(72) Inventors: KIRAN RAJU PENUMACHA, Hyderabad (IN); BHARAT MASIMUKKU, Wyndham Vale (AU); SAVANTH GATTU, Hyderabad (IN)

(21) Appl. No.: 18/460,900

(22) Filed: Sep. 5, 2023

(30) Foreign Application Priority Data
Sep. 6, 2022 (IN) 202241050850

(51) Int. Cl. G06Q 10/0631

(52) U.S. Cl. CPC G06Q 10/06313

(57) ABSTRACT

Disclosed is an autonomous resource planning device (104) that includes a processing circuitry (208) that is configured to receive one or more inputs representing static scores associated with one or more employees, compute a base score associated with each employee of one or more employees, allocate recent performance index score for each employee of one or more employees, generate a compound performance index score based on computing the base score and the recent performance index score of the one or more employees with time weight, generate index of fit score based on employee of one or more employees availability and workload details, and allocate highest ranked resource to a corresponding employee of the one or more employees with maximum index of fit score. The present disclosure also relates to a system (100) and a method (300) for managing resources.

### TECHNICAL FIELD

The present disclosure relates to the field of resource management system. More particularly, the present disclosure relates to device, system, and method of autonomous resource planning.

### BACKGROUND

In many organizations, resource management plays a crucial role. In general, resources needed to be identified and listed in a resource plan to finish a project. Because most of the organizational costs are resource-related, it is essential that they are utilized as effectively as possible. A resource plan serves as a guide to guarantee that projects are completed on time and within budget. But that's not a simple task, especially when resources are scarce and a variety of projects requiring a wide range of skill sets are in progress across an organization. Even project managers and others have difficulty prioritizing projects, allocating resources, and achieving maximum efficiency.

To handle this issue many organizations, use project portfolio management (PPM) solutions for prioritizing projects and resource management. This method provides enterprise-wide discernibility, allowing managers to anticipate resource demand and project risks. It also contributes to workforce future-proofing by providing data-driven insight and knowledge for timely decision-making. These applications help them to aggregate the resources available within the organization, categorize them, and add specific attributes such as skill sets, experience, and availability. This information allows them to assign tasks to individuals and teams based on those characteristics, while also maintaining and monitoring resource utilization and ensuring they are contributing to the highest value work.

However, as organizations grow in size, it becomes increasingly difficult to align different projects with high-level business objectives, and even these methods will be incapable of making difficult decisions while prioritizing tasks. If the wrong person is delegated to allocate resources, they may be subverted. The objective of resource management is to identify and assign the resources required to complete the work. People are the most important aspect for a company and the most valuable asset. They are also one of the most expensive options. As a result, understanding who we have in the organization, their availability to deliver projects, programs, and/or keep the lights on, and their talents, is an important part of resource planning. Aside from identifying the people we have, we must have a thorough understanding of their strengths and skill sets, especially if those skill sets are uncommon or in high demand. Many experts are difficult to find and can be very expensive.

In organizations previously, people were frequently assigned to teams simply because they were available at the time. Their skillsets and other work were given less consideration. As a result, skills gaps magnified project delays, even though the skills persisted somewhere in the company. Project delays frequently resulted in additional project delays. To avoid this, businesses have placed a strategic emphasis on resource utilization. But traditional resource planning methods relies on simple criteria frequently fail to produce predictable results in today's intricate tasks.

Therefore, there is a need for technology that overcomes these drawbacks, to optimize resource utilization and to find the best suitable resource for the given task.

### SUMMARY

In first aspect of the present disclosure, an autonomous resource planning device is provided.

The autonomous resource planning device includes a processing circuitry that is configured to receive one or more inputs representing static scores associated with one or more employees, compute a base score associated with each employee of one or more employees, allocate recent performance index score for each employee of one or more employees based on performances associated with a respective employee of one or more employees and corresponding weights associated with historic details, generate a compound performance index score based on computing the base score and the recent performance index score of the one or more employees with time weight, generate index of fit score based on an employee of one or more employees availability and workload details and allocate highest ranked resource to a corresponding employee of the one or more employees with a maximum index of fit score.

In some aspects of the present disclosure, the autonomous resource planning device includes a user device that is coupled with the processing circuitry and adapted to receive one or more inputs representing static scores associated with one or more employees, such that the processing circuitry is configured to compute a base score associated with each employee of one or more employees.

In some aspects of the present disclosure, the autonomous resource planning device further includes one or more employee devices that are coupled with the processing circuitry, such that the processing circuitry is adapted to receive data representing recent performance associated with each employee of one or more employees and generate the compound performance index score based on computing the base score and the recent performance index score of the one or more employees with time weight.

In second aspect of the present disclosure an autonomous resource planning system is provided.

The autonomous resource planning system includes a user device that is adapted to receive one or more inputs representing static scores associated with one or more employees and an autonomous resource planning device that includes a processing circuitry that is configured to receive one or more inputs representing static scores associated with one or more employees, compute a base score associated with each employee of one or more employees, allocate recent performance index score for each employee of one or more employees based on performances associated with a respective employee of one or more employees and corresponding weights associated with a historic details, generate a compound performance index score based on computing the base score and the recent performance index score of the one or more employees with time weight, generate index of fit score based on employee of one or more employes availability and workload details, and allocate highest ranked resource to a corresponding employee of the one or more employees with maximum index of fit score.

In some aspects of the present disclosure, the system further includes one or more employee devices that are coupled with the processing circuitry, such that the processing circuitry is adapted to receive data representing recent performance associated with each employee of one or more employees and generate the compound performance index score based on computing the base score and the recent performance index score of the one or more employees with time weight.

In some aspects of the present disclosure, the system in which the base score associated with the employee is computed based on the static features of the respective employee that is captured at the time of joining the organization, and the work experience associated with the respective employee and the work experience is selected from a group comprising qualifications, total work experience, relevant work experience, and total certifications.

In some aspects of the present disclosure, the system in which the time weight facilitates the autonomous resource planning system to adjust the base score and Recent Performance Index scores and further facilitates the prediction of the CPI score.

In some aspects of the present disclosure, the resource is determined based on the expected time of a certain task.

In third aspect of the present disclosure, a method for managing resources by way of an autonomous resource planning system is provided.

The method includes receiving, by way of a user device, one or more inputs representing static scores associated with one or more employees. The method further includes computing, by way of processing circuitry, a base score associated with each employee of one or more employees. The method further includes allocating, by way of the processing circuitry, recent performance index score for each employee of one or more employees based on performances associated with a respective employee of one or more employees and corresponding weights associated with a historic details. The method further includes generating, by way of the processing circuitry, a compound performance index score based on computing the base score and the recent performance index score of one or more employees with time weight. The method further includes generating, by way of the processing circuitry, index of fit score based on employee of one or more employees availability and workload details and the method further includes allocating, by way of the processing circuitry, highest ranked resource to a corresponding employee of the one or more employees with maximum index of fit score.

### BRIEF DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawing,

FIG. 1 illustrates a block diagram of an autonomous resource planning system, in accordance with an aspect of the present disclosure;

FIG. 2 illustrates a block diagram of an autonomous resource planning device, in accordance with an aspect of the present disclosure;

FIG. 3 illustrates a flowchart that depicts resource planning method by way of the autonomous resource planning device of FIG. 2, in accordance with an aspect of the present disclosure;

FIGS. 4A and 4B illustrates an exemplary flowchart representing beta update process, in accordance with an aspect of the present disclosure;

FIG. 5 illustrates a flowchart depicting employee availability, in accordance with an aspect of the present disclosure;

FIG. 6 illustrates a flowchart for experts assigned weights (EAS) to calculate the BPI score, in accordance with an embodiment of the present disclosure;

FIG. 7 illustrates a flowchart for onboarding new employee, in accordance with an embodiment of the present disclosure;

FIG. 8 illustrates a flowchart for new workflow status transaction, in accordance with an embodiment of the present disclosure; and

FIG. 9 illustrates a flowchart for configuring the ARP bot with the new workflow status transaction, in accordance with an embodiment of the present disclosure.

### DETAILED DESCRIPTION OF THE PREFERRED EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, known details are not described in order to avoid obscuring the description.

References to one or an embodiment in the present disclosure can be references to the same embodiment or any embodiment; and, such references mean at least one of the embodiments.

Reference to “one embodiment”, “an embodiment”, “one aspect”, “some aspects”, “an aspect” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided.

A recital of one or more synonyms does not exclude the use of other synonyms.

The use of examples anywhere in this specification including examples of any terms discussed herein is illustrative only, and is not intended to further limit the scope and meaning of the disclosure or of any example term. Likewise, the disclosure is not limited to various embodiments given in this specification. Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The term “Base Performance Index score” and “BPI score” are interchangeably used across the context.

The term “Recent Performance Index Score” and “RPI score” are interchangeably used across the context.

The term “Autonomous Resource planning system 100”, “ARP bot” and “system 100” are interchangeably used across the context.

The term “Compound Performance Index score” and “CPI score” are interchangeably used across the context.

The term “Index of Fit score” and “IoF score” are interchangeably used across the context.

The term “user” may refer to the person who enters the input value into the system, and is associated with an organization or a company.

The term “employee” may refer to one or more people who are employed or the person associated with the organization or company to whom the task, work, or resource is being allotted.

As mentioned before, there is a need for technology that overcomes these drawbacks, to optimize resource utilization and to find the most suitable resource for the given task. The present disclosure, therefore also provides an autonomous resource planning system to allocate tasks to the most suitable employee of one or more employees.

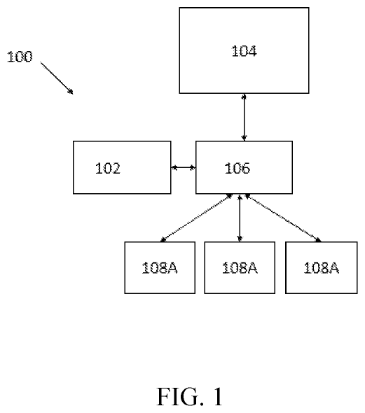

FIG. 1 illustrates an autonomous resource planning system 100, in accordance with an aspect of the present disclosure. The system 100 may include a user device 102 and an autonomous resource planning device 104. The user device 102 and the autonomous resource planning device 104 may be coupled with each other by way of a communication network 106. In some other aspects of the present disclosure, The user device 102 and the autonomous resource planning device 104 may be communicably coupled through separate communication networks established therebetween. In some aspects of the present disclosure, the communication network 106 may include suitable logic, circuitry, and interfaces that may be configured to provide a plurality of network ports and a plurality of communication channels for transmission and reception of data related to operations of various entities (such as the user device 102 and the autonomous resource planning device 104) of the system 100.

Each network port may correspond to a virtual address (or a physical machine address) for the transmission and reception of the communication data. For example, the virtual address may be an Internet Protocol Version 4 (IPV4) (or an IPV6 address), and the physical address may be a Media Access Control (MAC) address. The communication network 106 may be associated with an application layer for implementation of communication protocols based on one or more communication requests from the user device 102 and the autonomous resource planning device 104. The communication data may be transmitted or received via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In some aspects of the present disclosure, the communication data may be transmitted or received via at least one communication channel of a plurality of communication channels in the communication network 106. The communication channels may include but are not limited to, a wireless channel, a wired channel, or a combination of wireless and wired channel thereof. The wireless or wired channel may be associated with data standards which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Aspects of the present disclosure are intended to include or otherwise cover any type of communication channel, including known, related art, and/or later developed technologies.

The user device 102 may be adapted to receive one or more inputs representing static scores associated with one or more employees.

The user device 102 may be capable of facilitating a user to provide input data (such as one or more captured photos), share one or more results, and/or transmit data within the system 100. In some aspects of the present disclosure, the input data may include one or more captured images, one or more captured videos, and the like. It will be apparent to a person of ordinary skill in the art that the user may be any person using or operating the system 100, without deviating from scope of the disclosure. Examples of the user device 102 may include but are not limited to, a desktop, a notebook, a laptop, a handheld computer, a touch-sensitive device, a keyboard, a microphone, a mouse, a joystick, a computing device, a smart-phone, and/or a smartwatch. It may be apparent to a person of ordinary skill in the art that the user device 102 may include any device/apparatus that is capable of manipulation by the user.

The user device 102 may include an interface (not shown).

The interface may include an input interface (not shown) for receiving input data from the user. In some aspects of the present disclosure, the input interface may include but is not limited to, a touch interface, a mouse, a keyboard, a motion recognition unit, a gesture recognition unit, a voice recognition unit, or the like. Aspects of the present disclosure are intended to include and/or otherwise cover any type of interface, including known, related, and later developed interfaces.

The interface may further include an output interface (not shown) for displaying (or presenting) an output to the user. In some aspects of the present disclosure, the output interface may include but is not limited to, a display device, a printer, a projection device, and/or a speaker. In some other aspects of the present disclosure, the output interface may include but is not limited to, a digital display, an analog display, a touch screen display, a graphical user interface, a website, a webpage, a keyboard, a mouse, a light pen, an appearance of a desktop, and/or illuminated characters.

The user device 102 may further include a communication interface (not shown).

The communication interface may be configured to enable the user device 102 to communicate with the autonomous resource planning device 104 and other components of the system 100 over a communication network 106, according to an aspect of the present disclosure. In some aspects of the present disclosure, the communication interface may be one of but is not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. It will be apparent to a person of ordinary skill in the art that the communication interface may include any device and/or apparatus capable of providing wireless or wired communications between the user device 102 and the autonomous resource planning device 104.

The autonomous planning device 104 may be configured to receive one or more inputs representing static scores associated with one or more employees. The autonomous planning device 104 may further be configured to compute a base score associated with each employee of one or more employees. The autonomous planning device 104 may further be configured to allocate recent performance index score for each employee of one or more employees based on performances associated with a respective employee of one or more employees; and corresponding weights associated with a historic details. The autonomous planning device 104 may further be configured to generate a compound performance index score based on computing the base score and the recent performance index score of the one or more employees with time weight. The autonomous planning device 104 may further be configured to generate index of fit score based on employee of one or more employees availability and workload details. The autonomous planning device 104 may further be configured to allocate highest ranked resource to a corresponding employee of the one or more employees with maximum index of fit score.

The system 100 may further include one or more employee devices (108 A-N) that may be coupled with autonomous planning device 104 by way of a communication network 106.

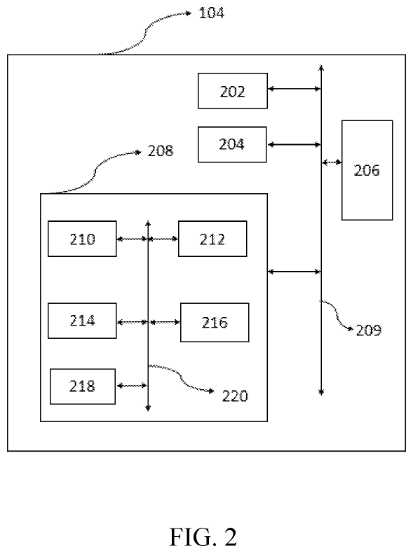

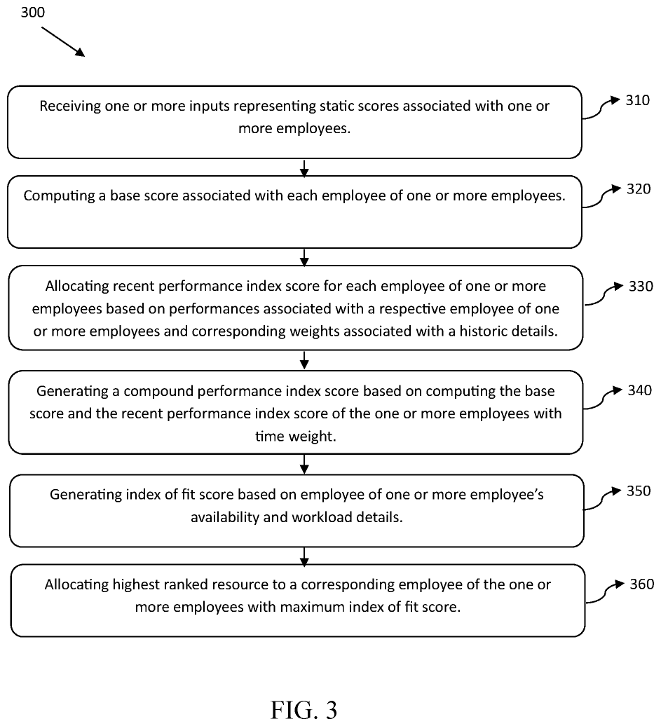

FIG. 2 illustrates the autonomous resource planning device 104, in accordance with an aspect of the present disclosure. The autonomous resource planning device 104 may be a network of computers, a framework, or a combination thereof, that may provide a generalized approach to creating the server implementation. Examples of the autonomous resource planning device 104 may include but are not limited to, personal computers, laptops, mini-computers, mainframe computers, any non-transient and tangible machine that can execute a machine-readable code, cloud-based servers, distributed server networks, or a network of computer systems. The autonomous resource planning device 104 may be realized through various web-based technologies such as, but not limited to, a Java web framework, a .NET framework, a personal home page (PHP) framework, or any other web application framework.

The autonomous resource planning device 104 may include a network interface 202, an I/O interface 204, a storage unit 206, and one or more processing circuitries of which processing circuitry 208 is shown.

The processing circuitry 208, the storage unit 206, the network interface 202, and the I/O interface 204 may communicate with each other by way of a first communication bus 209. It will be apparent to a person having ordinary skill in the art that the autonomous resource planning device 104 is for illustrative purposes and not limited to any specific combination of hardware circuitry and/or software.

The network interface 202 may include suitable logic, circuitry, and interfaces that may be configured to establish and enable a communication between the autonomous resource planning device 104 and different components of the system 100. The network interface 202 may be implemented by use of various known technologies to support wired or wireless communication of the information processing device 104 with the communication network 106. The network interface 202 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit.

The I/O interface 204 may include suitable logic, circuitry, interfaces, and/or code that may be configured to receive inputs (e.g., orders) and transmit server outputs via a plurality of data ports in the autonomous resource planning device 104. The I/O interface 204 may include various input and output data ports for different I/O devices. Examples of such I/O devices may include but are not limited to, a touch screen, a keyboard, a mouse, a joystick, a projector audio output, a microphone, an image-capture device, a liquid crystal display (LCD) screen, and/or a speaker.

The storage unit 206 may be configured to store logic, instructions, circuitry, interfaces, and/or codes of the processing circuitry 208 to enable the processing circuitry 208 to execute the one or more operations associated with the system 100. The storage unit 206 may be further configured to store therein, data associated with the system 100, and the like. It will be apparent to a person having ordinary skill in the art that the storage unit 206 may be configured to store various types of data associated with the system 100, without deviating from the scope of the present disclosure. Examples of the storage unit 206 may include but are not limited to, a Relational database, a NoSQL database, a Cloud database, an Object-oriented database, and the like. Further, the storage unit 206 may include associated memories that may include, but is not limited to, a Read-Only Memory (ROM), a Random Access Memory (RAM), a flash memory, a removable storage drive, a hard disk drive (HDD), a solid-state memory, a magnetic storage drive, a Programmable Read Only Memory (PROM), an Erasable PROM (EPROM), and/or an Electrically EPROM (EEPROM). Embodiments of the present disclosure are intended to include or otherwise cover any type of the storage unit 206 including known, related art, and/or later developed technologies. In some embodiments of the present disclosure, a set of centralized or distributed networks of peripheral memory devices may be interfaced with the autonomous resource planning device 104, as an example, on a cloud server.

The processing circuitry 208 may be configured to execute various operations associated with the system 100. Specifically, the processing circuitry 208 may be configured to execute the one or more operations associated with the system 100 by communicating one or more commands and/or instructions over the communication network 106 to the user device 102 and the autonomous resource planning device 104. Examples of the processing circuitry 208 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Embodiments of the present disclosure are intended to include and/or otherwise cover any type of the processing circuitry 208 including known, related art, and/or later developed technologies.

The processing circuitry 208 may further include Base Performance Index (BPI) engine 210, Recent Performance Index (RPI) engine 212, Compound Performance Index (CPI) engine 214, Availability & Workload 216, and Index of Fit (Iof) engine 218. The processing circuitry 208, the storage unit 206, the network interface 202, and the I/O interface 204 may communicate with each other by way of a second communication bus 220.

The Base Performance Index (BPI) engine 210 may be configured to receive one or more inputs representing static scores associated with one or more employees. The Base Performance Index (BPI) engine 210 may further be configured to compute a base score associated with each employee of one or more employees. The Recent Performance Index (RPI) engine 212 may be configured to allocate recent performance index score for each employee of one or more employees based on performances associated with a respective employee of one or more employees and corresponding weights associated with a historic details. Compound Performance Index (CPI) engine 214 may further be configured to generate a compound performance index score based on computing the base score and the recent performance index score of the one or more employees with time weight. Index of Fit (Iof) engine 218 may further be configured to generate index of fit score based on employee of one or more employees availability and workload details 216. processing circuitry 208 may be configured to allocate highest ranked resource to a corresponding employee of the one or more employees with maximum index of fit score.

In some aspect of the present disclosure, the BPI score may be a base score computed once with static factors captured at the time of joining of an employee to the organization. In some aspect of the present disclosure, the BPI score of the employees is based on historical details such as qualification, total experience, relevant experience, total certifications, etc. In some aspect of the present disclosure, the BPI score uses the Multicriteria Decision making (AHP, TOPSIS, ELECTRE) process to determine the weights of the factors. In some aspect of the present disclosure, Analytical Hierarchy Process (AHP) may be one such Multicriteria Decision-making instruction that may be used to compute the weights of factors in the proposed invention.

In some aspect of the present disclosure the Recent Performance Index (RPI) engine 212 aggregates multiple machine learning instructions to determine betas and calculate the betas for the dynamic features using a beta update process, wherein Betas or Weights are Updated in the system for every new transaction records or updating of scores and the Recent Performance Index Score may be an auto-computed machine-assigned scores (MAS) used to rate the resources based on the recent performance factors and the corresponding weights of the resources.

In some aspects of the present disclosure, the time weight may be a parameter utilized to adjust the Base Performance Index score and Recent Performance Index scores to predict the Compound Performance Index score over time and also the transaction weight is a parameter used to adjust the Base Performance Index score and Recent Performance Index scores to predict the Compound Performance Index score depending upon the transaction count.

In some aspect of the present disclosure, the Recent Performance Index (RPI) engine 212 may be adapted to compute Recent Performance Index scores of employees based on the employee recent performance factors such as total jobs completed, total deliveries completed, total rollbacks, etc. and their corresponding weights.

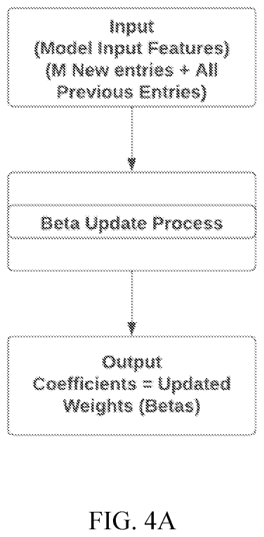

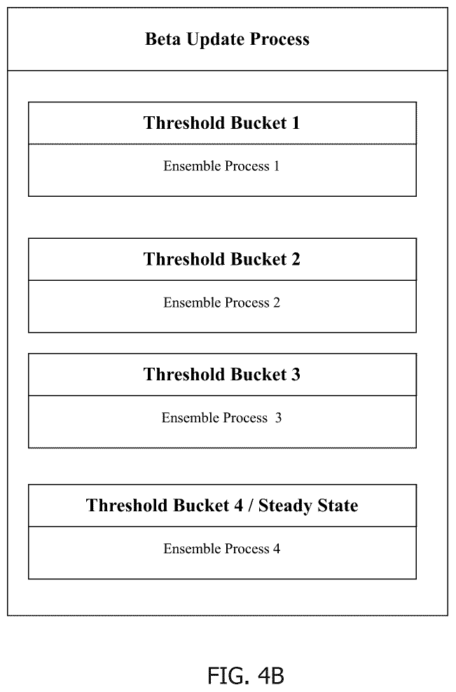

In some aspect of the present disclosure, when a certain number of transactions are completed. In some aspect of the present disclosure, when the number of transactions reaches a predefined limit, all data from the database is retrieved, and the beta update process begins. In some aspect of the present disclosure, the beta update process produces updated weights (betas) for all dynamic factors as shown in FIG. 4a and FIG. 4b.

In some aspect of the present disclosure, depending upon the volume of transactions different thresholds will be activated and each threshold bucket contains an ensemble of machine learning instruction. In some aspect of the present disclosure, the amount of data grows, more powerful and robust instructions are invoked and trained as shown in the FIG. 4b.

In some aspect of the present disclosure, the CPI score is a score that coalesces employee's historical data and recent performance data. In some aspect of the present disclosure, the time weight and the transaction weight are parameters used to adjust the BPI and RPI score to predict the CPI score over time or over transaction count. In some aspect of the present disclosure, the type of computation is utilized to avoid biasness of years of experience.

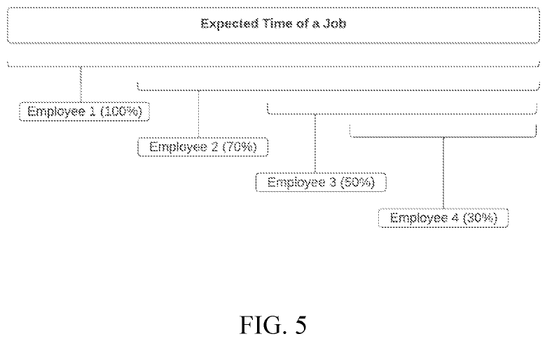

In some aspect of the present disclosure, the employee availability engine 216 contains details of all the employees who are currently in that status and their availability to work on the next task. In some aspect of the present disclosure, the employee availability is calculated based on the expected time of a certain job as shown in FIG. 5.

In some aspects of the present disclosure, the IoF score is a final score used to rank the employees and it is a combination of the CPI score and the employee availability. In some aspect of the present disclosure, the employee availability and the workload details refer to each employee available time in relation to the expected time of a certain job. In some aspect of the present disclosure, the employee with a high IoF is ranked highest and the task is allocated to the highest ranked employee. In some aspect of the present disclosure, the score from the BPI, RPI, CPI and employee availability/workload modules are combined to yield IoF score.

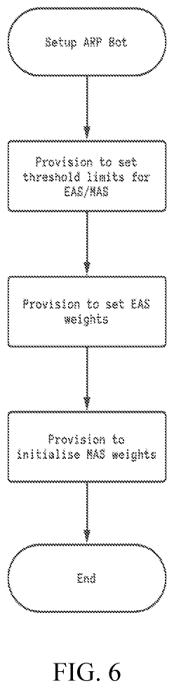

In some aspect of the present disclosure, the system is fed with experts assigned weights (EAS) to calculate the BPI score of the employee. In some aspect of the present disclosure, at the beginning of the system 100, there is a provision to set threshold limits for the EAS and MAS parameters. In some aspect of the present disclosure, following the assignment of the EAS weights, the auto-computed MAS weights are initialized to predict the RPI score as shown in FIG. 6.

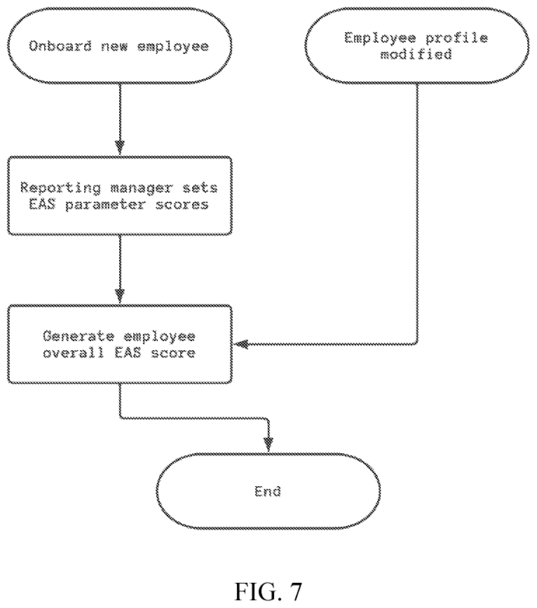

In some aspect of the present disclosure, once a new employee joins the organization, the employee historical information is collected and given to the reporting manager. In some aspect of the present disclosure, the reporting manager assigns an expert assigned score (EAS) to each of the employee historical features, and the BPI score is calculated. In some aspect of the present disclosure, If any of the current employee profiles are changed again, the corresponding employee BPI score will be recalibrated as shown in FIG. 7.

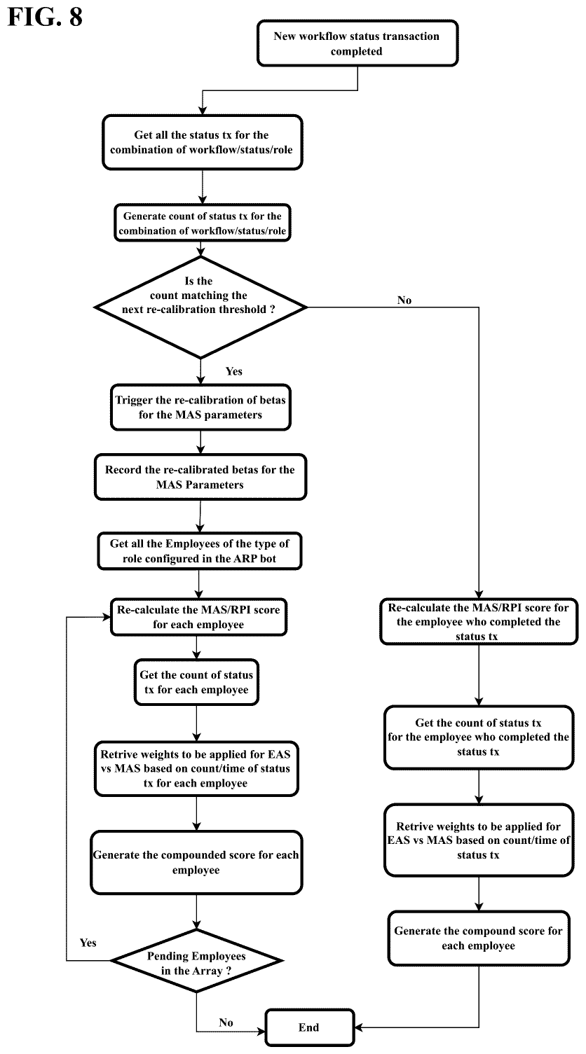

In some aspect of the present disclosure, when a new workflow status transaction is completed, need to fetch all the task transaction data from the database of the same role/status and count the number of transactions. In some aspect of the present disclosure, if the transaction count matches the recalibration threshold, trigger the training process to calculate the beta updates for the MAS parameters. In some aspect of the present disclosure, after the completion of training, fetch the details of all the employees of the same role/status from the database into the ARP bot and calculate the RPI and if not, calculate the RPI based on the previously updated betas or trained weights. In some aspect of the present disclosure, after computing, the EAS/BPI and MAS/RPI scores for all the employees in the given status, the CPI score is calculated based on the time weight or transaction weight of the RPI and BPI score as shown in FIG. 8.

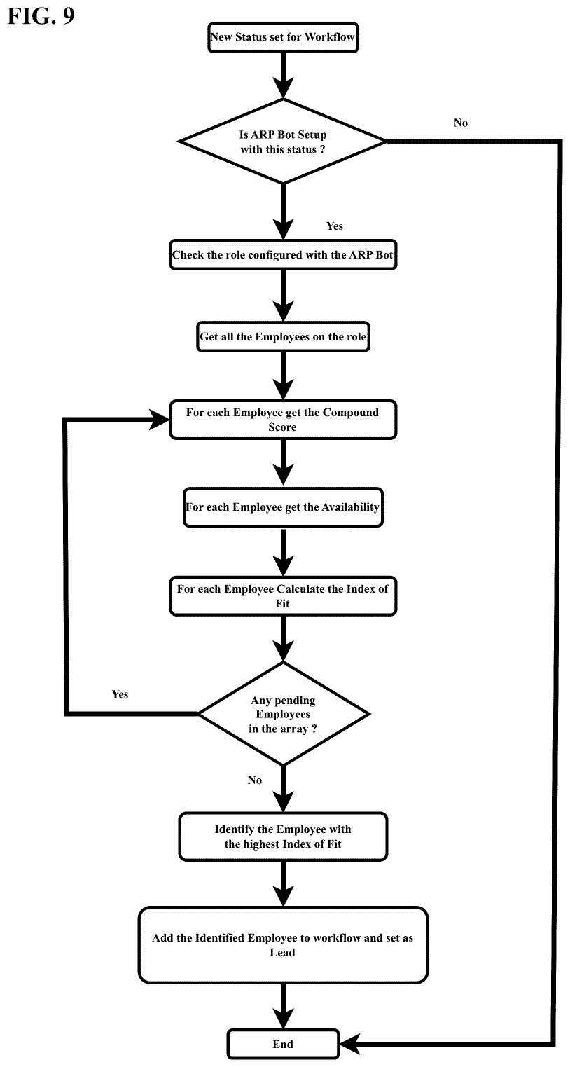

In some aspect of the present disclosure, Once a new status is set for the workflow and the system 100 is configured with this status, the role configured with the system 100 is checked, and fetches the details of all the employees from the database with the configured role. In some aspect of the present disclosure, once all the employee details are fetched from the database, the CPI score and the availability of each employee is collected, and the IoF is calculated. In some aspect of the present disclosure, after finding the IoF, employees with the highest IoF are ranked first, and the tasks are assigned to the highest ranked employees as shown in FIG. 9.

Advantages:
The present disclosure provides the system 100 that performs efficient resource allocation based on employee scores and performance metrics.
The present disclosure provides the system 100 that performs objective decision-making without subjective biases.
The present disclosure provides the system 100 that performs real-time performance tracking for up-to-date evaluation.
The present disclosure provides the system 100 that improvise productivity through task assignment based on employee fit scores.
The present disclosure provides the system 100 that performs balanced distribution of workload and prevention of overburdening.
The present disclosure provides the system 100 that performs time optimization by prioritizing recent performance.
The present disclosure provides the system 100 that can be scalable and adaptable to different organizational needs.
The present disclosure provides the system 100 that can be adapted to enhance employee satisfaction through fair resource allocation.
The present disclosure provides the system 100 that provide Transparency and accountability in resource planning processes.
The present disclosure provides the system 100 that can optimize utilization of time and resources for better organizational performance.

The implementation set forth in the foregoing description do not represent all implementations consistent with the subject matter described herein. Instead, they are merely some examples consistent with aspects related to the described subject matter. Although a few variations have been described in detain above, other modifications or additions are possible. In particular, further features and/or variations can be provided in addition to those set forth herein. For example, the implementation described can be directed to various combinations and sub combinations of the disclosed features and/or combinations and sub combinations of the several further features disclosed above. In addition, the logic flows depicted in the accompany figures and/or described herein do not necessarily require the particular order shown, or sequential order, to achieve desirable results. Other implementations may be within the scope of the following claims.

I/We claim:

1. An autonomous resource planning device (104) comprising:
a processing circuitry (208) that is configured to:
(i) receive one or more inputs representing static scores associated with one or more employees;
(ii) compute a base score associated with each employee of one or more employees;
(iii) allocate recent performance index score for each employee of one or more employees based on:
(a) performances associated with a respective employee of one or more employees; and
(b) corresponding weights associated with a historic details;
(iv) generate a compound performance index score based on computing the base score and the recent performance index score of the one or more employees with time weight;
(v) generate index of fit score based on employee of one or more employees availability and workload details; and
(vi) allocate highest ranked resource to a corresponding employee of the one or more employees with maximum index of fit score.

2. The autonomous resource planning device(104) as claimed in claim 1, further comprising a user device (102) that is coupled with the processing circuitry (208) and adapted to receive one or more inputs representing static scores associated with the one or more employees, such that the processing circuitry (208) is configured to compute a base score associated with each employee of one or more employees.

3. The autonomous resource planning device(104) as claimed in claim 1, further comprising one or more employee devices (108A-N) that are coupled with the processing circuitry (208), such that the processing circuitry is (208) adapted to
(i) receive data representing recent performance associated with each employee of one or more employees; and
(ii) generate the compound performance index score based on computing the base score and the recent performance index score of the one or more employees with time weight.

4. An autonomous resource planning system (100) comprising:
a user device (102) that is adapted to receive one or more inputs representing static scores associated with one or more employees;
an autonomous resource planning device (104) comprising:
a processing circuitry (208) that is configured to:
(i) receive one or more inputs representing static scores associated with one or more employees;
(ii) compute a base score associated with each employee of one or more employees;
(iii) allocate recent performance index score for each employee of one or more employees based on:
(a) performances associated with a respective employee of one or more employees; and
(b) corresponding weights associated with a historic details;
(iv) generate a compound performance index score based on computing the base score and the recent performance index score of the one or more employees with time weight;
(v) generate index of fit score based on employee of one or more employees availability and workload details; and
(vi) allocate highest ranked resource to a corresponding employee of the one or more employees with maximum index of fit score; and
one or more employee devices (108A-N) that are coupled with the processing circuitry (208), such that the processing circuitry (208) is adapted to
(i) receive data representing recent performance associated with each employee of one or more employees; and
(ii) generate the compound performance index score based on computing the base score and the recent performance index score of the one or more employees with time weight.

5. The autonomous resource planning system (100) as claimed in claim 4, wherein the base score associated with the employee is computed based on the static features of the respective employee that is captured at time of joining the organization, and the work experience associated with the respective employee.

6. The autonomous resource planning system (100) as claimed in claim 5, wherein the work experience is selected from a group comprising qualifications, total work experience, relevant work experience, and total certifications.

7. The autonomous resource planning system (100) as claimed in claim 4, wherein the time weight facilitates the autonomous resource planning system (100) to adjust the base score and Recent Performance Index scores and further facilitates to predict the Compound Performance Index score.

8. The autonomous resource planning system (100) as claimed in claim 4, wherein the resource is determined based on expected time of a certain task.

9. A method (300) for managing resources by the way of an autonomous resource planning (ARP) system, the method comprising:
receiving (310), by way of a user device (102), one or more inputs representing static scores associated with one or more employees;
computing (320), by way of processing circuitry(208), a base score associated with each employee of one or more employees;
allocating (330), by way of the processing circuitry(208), recent performance index score for each employee of one or more employees based on:
(a) performances associated with a respective employee of one or more employees; and
(b) corresponding weights associated with a historic details;
generating (340), by way of the processing circuitry(208), a compound performance index score based on computing the base score and the recent performance index score of the one or more employees with time weight;
generating (350), by way of the processing circuitry(208), index of fit score based on employee of one or more employees availability and workload details; and
allocating (360), by way of the processing circuitry (208), highest ranked resource to a corresponding employee of the one or more employees with maximum index of fit score.
